(19) United States
(12) Patent Application Publication
(10) Pub. No.: US 2003/0126465 A1
(43) Pub. Date: Jul. 3, 2003

(54) Internet-based card access and security systems and methods

(76) Inventors: Joseph Tassone, Lexington, MA (US); David M. Singer, South Windsor, CT (US)

Correspondence Address: IMONITOR CORPORATION, 133 MASSACHUSETTS AVENUE, LEXINGTON, MA, 02420, US

(21) Appl. No.: 10/036,647

(22) Filed: Dec. 31, 2001

(51) Int. Cl. H04L 9/00

(52) U.S. Cl. 713/201

(57) ABSTRACT

An Internet-based card access and security system and method, the system comprising at least one Internet client station, at least one Internet host center and an intelligent card access controller with related hardware components. The Internet client station is linked to an Internet cloud, and provides a connection and user interface for an individual who is using the Internet client station. The Internet host center is also linked to the Internet cloud and provides the data repository for the card access and/or security system along with the logic for handling access and security inputs and for processing, interpreting, filtering, disseminating, and storing the source of inputs and resulting actions according to the configured rules. The Internet host center is linked to one or more Internet clients as well as multiple controllers representing different customers and different installations. The Internet host center, having records of one or more enrolled customer sites, provides for multiplexing of the input data with selected instances of the handling logic and data records. The method comprises the steps of (i) establishing parameters associated with the operational characteristics to be used with this particular instance; (ii) acquiring, at the Internet client station, requests for information and associated system operation commands; (iii) receiving, at the Internet host center, messages from card access controllers that includes security and access data; (iv) multiplexing, at the Internet host center, one or more messages to the appropriate handler for this instance from among the multiple instances being handled; (v) processing the messages according to the rules set for this instance, and (vi) responding to the Internet client request with results, reports, and alarm data on a real time manner and selected by client station and operator. The system and method provide for complete system integrity and operation and user access from any convenient and non-dedicated location that has an Internet connection and Internet browser.

### BACKGROUND OF INVENTION

This invention relates to card access and security, particularly to systems and methods for card access and security employing the Internet.

Broadly described, the World Wide Web (the “Web”) is a decentralized, electronic database service offering a universe of dynamically connected information and computing systems, the information being in any of various media and being relatively easily found by and made accessible to individuals or systems exploring (“surfing”) that universe. The backbone of this service is a wide reaching communication system that connects these disparate sources of information and computing resources (the “Internet”). More specifically, the Internet is a distributed, communication system comprising low speed and high-speed telecommunication lines, linking Internet servers and Internet clients. Internet clients include software programs commonly known as browsers. Browsers typically reside on an individual's computer and, among other things, provide for exploring the Internet so as to find and access Web documents and interact with Internet server systems.

Internet servers are software programs that support various features, including being compatible with one or more standard protocols, e.g., HyperText Markup Language (“HTML”), the standard language for data formatting and presentation and the HyperText Transport Protocol (“HTTP”), the well-known, native protocol of the Internet generally unifying its information delivery. Internet servers generally hypermedia documents on the Web and otherwise make resources associated with the server available to Internet clients. Internet servers not only make documents and resources accessible to Internet clients, but also direct specific data to clients and complete transactions responsive to each client's input. Internet servers, being decentralized but interconnected, give the Internet its distributed characteristic.

Card Access is a facility security function that controls people“s access to facilities and particular areas within facilities and provides critical information for secure business operations. The use of Card Access has progressed steadily over the past thirty years, as has the technology employed. It is currently utilized in all sorts of office and commercial buildings, manufacturing facilities, parking garages, elevators, dormitories, and the like. It grew out of military and secret government applications and has gone mainstream. A simplified version is used in most hotel rooms. Card Access solutions are now mandated by the FAA at most airports and are incorporated into security programs at all medium and large colleges and universities to enhance safety and protect people and property.

A basic Card Access system is comprised of a reader at the door or gate, electronic door locking hardware, an intelligent controller, and a computer system that maintains the basic logic of who is allowed to go where, when and performs the database management function. The user of the system carries a token, usually in the form of a card, which holds a unique identification number (ID). They present the token to the reader to read the identification number and send it to the controller for verification of access privileges. The ID number is checked to confirm that this ID is allowed access at this door and on this day and time. If accepted, the door or gate is unlocked for a specific length of time and the user can enter the facility.

Many tokens have been developed over the years to address security, reliability, cost, and convenience. Today the prevalent cards include bar code, magnetic stripe (like a credit card), and proximity. The proximity or prox card uses a form of radio frequency to send a signal to the reader as the ID code. It has become a very popular card, as its cost decreased and reliability increased, due to user convenience. Given its radio frequency nature it does not have to be inserted into a reader slot or opening but can be read when in “proximity” to the reader. Today many prox cards can be read when worn on a person or still in a person“s wallet or purse.

Card Access systems also perform security functions in the form of monitoring people“s access activities and alerting operators of unauthorized access attempts. These are in the form of messages and alarms indicating a particular, John Doe cardholder, was “denied access” at a particular entry point (door). They also perform more general security functions in the monitoring of doors for unauthorized opening or “forced entry”. The systems have also progressed to providing complete, generalized security functionality for monitoring alarm conditions for intrusion detection at doors, fences, windows, motion detection, and the like.

Card Access systems are complex. They comprise electronic door hardware, card readers, networked intelligent controllers; a computer server consisting of advanced operating system software, real time alarm and event handling applications software, a database, a backup and archiving facility, a local area network (LAN); and one or more workstations to provide operator access for setting up, configuring, performing data entry, receiving alarm and event information, and generally operating the system. The workstations consist of additional computers that typically have their own operating system, application software, and local database.

Today“s systems are expensive and present challenges to current owners and operators that are not computer experts and do not have advanced training in information technologies. Requirements of current systems include:

1. The use of a server class computer system to execute the Card Access software and database engine employed with such systems. These servers are usually dedicated to the Card Access function thereby increasing cost. The servers are either housed in a special computer room usually designed for such purposes further increasing costs or at a the desk of a Security Guard not having the proper environment thereby reducing reliability and data security.

2. The use of workstation class computer systems to execute client Card Access software to operate the systems and receive operational information. These workstations are usually dedicated to the Card Access function thereby increasing costs or shared with other uses thereby potentially compromising security.

3. The custom installation of proprietary Card Access software on the server computer machine and every workstation that requires operational access to the system. This installation requires a customer or installer hours of time to perform and verify for proper operation thereby increasing costs. In systems that do not have dedicated computer systems for the servers and workstations, potential conflicts can be encountered between existing programs and new installed software. Conflicts are very difficult to predict and diagnose and are virtually not testable by any supplier given the multitude of software applications available today.

4. The setup and commissioning of the computer server and workstations to operate in a particular“s users LAN network environment. Today“s computer systems employ varied communications media (Ethernet, Token Ring, Wireless, Fiber, etc) and varied protocols (TCP/IP, Novell, AppleTalk, SNA, SMNP, etc). Significant expertise is required to setup and ensure proper operation at different locations with unique conditions.

5. The setup and configuring of backup and archiving systems and procedures to protect the system operation from hardware or software failures. Procedures to restore a system or database are very infrequently performed and are usually prone to time consuming errors and miss-queues.

6. The periodic upgrading of system software at computer servers and every workstation as new software revisions are released. A user or installer can spend hours re-installing and confirming operation of the new system once upgraded. New and old conflicts can be uncovered between software applications.

In today's information critical world, a significant aspect of a Card Access system is its facility for data entry, data management, data retrieval, and report generation. People“s profiles need to be changed as names, titles or privileges change. New people come and go that have to be updated into the system. Also, a log is kept of all accesses and typically the information must be periodically accessed to run management reports of cardholders and their activities.

Today“s systems generally limit access for such operations to users at designated workstations. An operator must utilize the software loaded on a dedicated or shared workstation for access to data, obtain reports, or real time events. This is a direct result of on premise computers and software.

A system that provided all card access functionality without the need for dedicated computer hardware and software would be of great advantage and more cost effective. A system that was available to a user to configure and operate their system from any location they may be would be more convenient and useful.

Accordingly, a need exists for an improved Card Access system, and methods to implement such systems. Moreover, a need exists for improved user access to these systems.

### SUMMARY OF INVENTION

An object of this invention is to provide improved, Internet-based card access and security systems, and methods to implement such Internet-based card access and security systems.

It is an objective of the present invention to remove the requirement for any dedicated, computer hardware on-premise for the system. It is also an objective to not require the specialized installation or setup of any dedicated computer software on premises for a Card Access and security system.

It is an objective of the present invention to remove the on-premise limitation of users and provide access to users of the system from any remote locations.

It is further an objective of this invention to provide access to users over the Internet from any location they may be. It is further an objective of this invention to provide access in a secure way utilizing secure Internet protocols.

Accordingly to one aspect of the invention, an Internet-based card access and security system is provided that uses the Internet cloud as a communication medium. The system comprises, in an embodiment, at least one Internet connected client station, at least one Internet host center station, and at least one Internet connected intelligent Card Access and security controller.

The individual using the Internet client station, whose access is dependent on user authentication, obtains access to the Internet host center via the Internet cloud. The Internet client station is linked to the Internet cloud, and provides selected requests for data representing system operation commands. The Internet host center is also linked to the Internet cloud. The Internet host center responds to requests with data, screens, and reports to fulfill the requests. Complete system command and control functions are provided using this communication facility.

In another aspect of the invention, a method is provided for Internet-based, delivery of alarm and card access information to individuals who are using an Internet client station, seeking access to unsolicited event information. An embodiment of the method comprises the steps of; (i) establishing parameters associated with selected events to be communicated for identification and routing; (ii) acquiring, at the intelligent card access and security controller event information data in accordance with the parameters; (iii) receiving, at the Internet host center, a message that includes the event data; (iv) determining, at the Internet host center, one or more Internet client stations from among the one or more enrolled client stations registered to receive this event or alarm; and (v) logging this activity in the historical event log for future reporting.

The various features of novelty, which characterize the invention, are pointed out with particularity in the claims annexed to and forming a part of this specification. For a better understanding of the invention, its operating advantages and specific objects attained by its use, reference should be made to the accompanying drawings and descriptive matter in which its preferred embodiments are illustrated and described.

### BRIEF DESCRIPTION OF DRAWINGS

In the drawings:

FIG. 1 is a block diagram of an embodiment of an Internet-based card access and security system, according to the present invention;

FIG. 2 is a block diagram of a client portion of FIG. 1, showing additional detail of the Internet-based card access and security system, according to the present invention;

FIG. 3 is a block diagram of intelligent card access and security controller portion of FIG. 1, showing additional detail of the Internet-based card access and security system, according to the present invention;

FIG. 4 is a block diagram of the Internet host center of FIG. 1, showing additional detail of the Internet-based card access and security system, according to the present invention; and

FIG. 5 is a flow-chart showing steps generally associated with the delivery of an alarm or event through an Internet-based card access and security system, according to the invention.

### DETAILED DESCRIPTION

The present invention contemplates Internet-based card access and security systems and methods. Card access relies on the reading of a token“s data in the possession of an individual and presented to a reader so as to provide access to the individual through a specific portal. The verification includes the validity of the token“s information, the date and time access is being requested, and the specific portal of entry. Basically the “who, where, and when” to provide access.

Internet-based card access and security introduces the Internet as the communication media for this transaction and it“s setup, configuration, and reporting.

Internet-based Card Access and security exploits the fact that such transactions are configured in a database and then selectively distributed to intelligent card access controllers for execution. Once downloaded to an intelligent card access controller then the activity is autonomously executed at the controller. The activity (“event”) is logged and communicated back to the host whether the transaction was “admitted” or “denied”.

The host receives this activity and processes it according to prescribed and configured rules. This includes logging the event into a log for subsequent reporting and archiving, and redistributing the event to clients subscribed to receive this and similar events. This redistribution is from the Internet host center to one or more Internet client stations also connected to the Internet cloud.

It is to be understood that the systems and methods described herein is also directed to security monitoring, without departing from the principles of the invention. By comparison to card access, security generally applies to monitoring a sensor or activity and deviation from a normal state. Upon detection of a deviation, an event or alarm is generated for logging, annunciation, and/or action. In a preferred embodiment, this event is prioritized and sent to the host on a priority basis. Similar processing of logging, reporting, and redistribution is contemplated to client stations. A related security event could be an unauthorized attempt at access to a restricted zone by a particular token holder.

Card Access and Security Systems

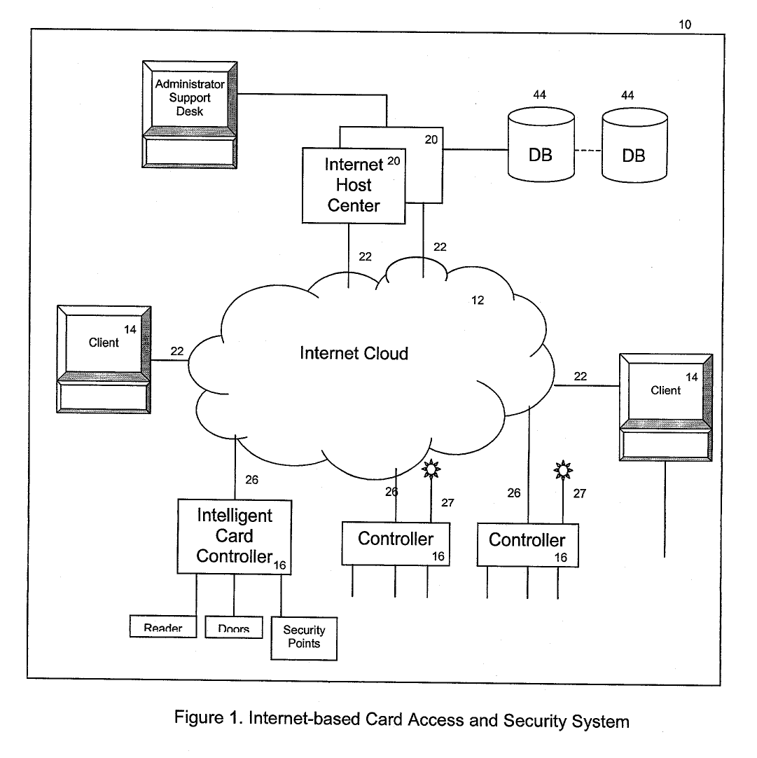

As shown in FIG. 1, an Internet-based card access and security system 10 according to the present invention comprises an Internet cloud 12, one or more Internet client stations 14, one or more Internet host centers 20, Internet connections 22 and 26, and one or more card access controllers 16. While the elements of the system 10 are shown as logical devices, one of ordinary skill in the art would readily understand that each is associated with respective physical devices. For example: (i) the stations 14 and 20 typically are associated with, among other physical devices, computers, such as PCs and servers; (ii) the connections 22 and 26 typically are associated, among other physical devices, with wires, cables, fiber optics, radio signals or other physical connections; and (iii) the Internet cloud 12 typically is associated with, among other physical devices, network components such as routers, bridges, computers, internets, intranets, extranets and other physical networks.

The Internet cloud 12 represents a generalized communication medium, based on and supporting standard protocols of the Internet (e.g., HTTP), for Internet transactions among the Internet's clients and servers. It represents either the network of a particular company or any other Internet, public and private.

The Internet connections 22 link each of the Internet client stations 14 to the Internet host centers 20 via the interposed Internet cloud 12 so as to provide Internet communications there among. The Internet connections 22 preferably support HTTP, as well as a secure transport protocol. The secure transport protocol preferably is the Secure Sockets Layer (“SSL”). SSL is an open, nonproprietary protocol offered by many companies including Microsoft Corporation of Redmond, Wash. (“Microsoft”). SSL is designed for use by Internet clients and servers, providing for data encryption, server authentication, message integrity and, optionally, user certificates. As to data encryption, SSL allows a client and server to negotiate an encryption algorithm, such as a public key algorithm (e.g., RSA), and to communicate securely using encryption.

Notwithstanding the above discussion, it is to be recognized that other protocols can be used without departing from the principles of the invention, provided that the protocols both support transport security and maintain overall operation of the system 10. An example is the IIOP (“Internet Inter-ORB Protocol”) of COBRA (“Collaborative Object Broker Request Architecture”), a standard specified by the OMG (Object Management Group)—a standard group of 700 computer and communication vendors that define distributed object computing interoperability).

The Intelligent Card Access and Security controller connections 26 preferably link the Intelligent Card Access controller 16 to the Internet cloud 12, so as to provide communication between the center 20 and the controllers 16. The controller connections 26 support a secure transport protocol, such as SSL, so as to provide a secure channel. The controller center connections 26 can also support a standard protocol, e.g., HTTP, although it is to be recognized that the system can be configured in the absence of that support. The Intelligent Card Access and Security controller connections 26 are depicted in FIG. 1 so as to indicate that the link can be redundant to the Internet cloud 12. For example, the link can be made wired directly between the controllers 16 and the Internet cloud 12. In this case, the system 10 takes advantage of the Internet's ubiquity and scalability. In the case of a direct link, the system 10 takes advantage of the cost effectiveness generally associated with such links. Alternatively, the link can be both direct and/or via a wireless connection 27 to the Internet cloud, which combination introduces the advantages of redundancy to those previously described, typically at only a marginal additional cost. It is to be recognized that each case is contemplated individually and separately as well as in combination within the principles of the invention.

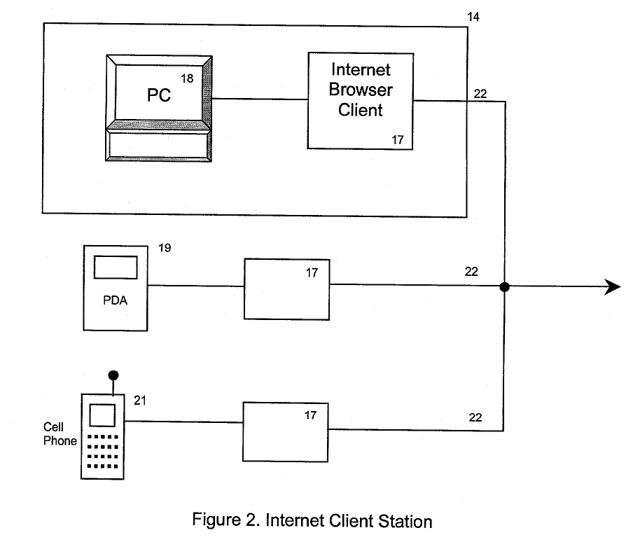

Turning to FIG. 2, an exemplary Internet client station 14 from FIG. 1 is shown in greater detail. The Internet client station 14 comprises one or more computing devices and an Internet client 17. Each of the devices 18, 19, and 21 are linked to an Internet client 17. In addition, the Internet client station 14 is linked via the connection 22 to the Internet cloud 12 at the Internet client 17.

The Internet client 17 preferably comprises any of the known browser programs, such as Microsoft“s Internet Explorer and Netscape's Navigator-brand browser. Although standard browser programs are preferred, it is to be recognized that other Internet clients (e.g. PDA“s, Cell Phones) can be used without departing from the principles of the invention, provided such clients are compatible with the system 10 protocols and are able to perform the steps of an authentication method associated with the client station 14, as described below. It is also to be recognized that the type of Internet client 17 can vary among the Internet client stations 14, without departing from the principles of the invention.

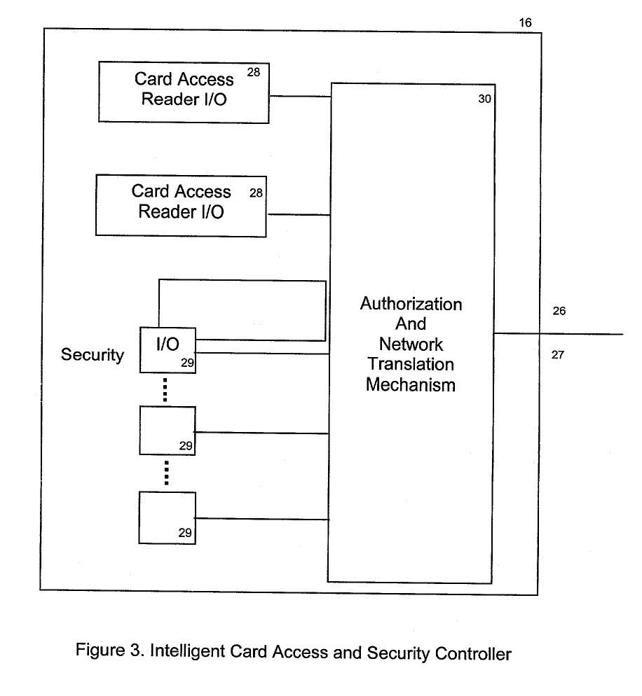

FIG. 3 shows an exemplary Intelligent Card Access and Security controller 16 in greater detail. The card access I/O devices 28, preferably comprise products capable of inputting data from card readers and other biometric input devices and otherwise generating events to send to the Internet host center 20. Numerous such products are known that can serve as card access I/O devices 28. For example, card readers offered by (i) HID Corp., of Irvine, Calif. (“HID”) and (ii) AWID Co., of Monsey, N.Y. and biometrics from (i) Recognition Systems, Inc., Campbell, Calif. and (ii) Identix Co., Sunnyvale, Calif. Although the intelligent Card Access controller 16 preferably includes one or more card access I/O devices 28, it is to be recognized that the controller 16 can omit such devices entirely, without departing from the principles of the invention.

The non-card access I/O devices 29 comprise technologies that acquire selected input data relating to physical sensing of a security point. The technologies commonly include one or more known hardware sensors and associated conditioning electronics interfaced to appropriate software; the sensor produces a signal representative of an alert condition. If, for example, the sensor is a window break detector, the sensor is used to capture a pattern, whose amplitude (voltage or current) varies with time in response to the physical integrity of the glass.

It is to be recognized that various of the card access I/O devices 28 and the non-card access I/O devices 29 can be implemented in single physical units, without departing from the principles of the invention. For example, a hand geometry reader can provide for input for card access data via recognition software as well as door monitor status. Similarly, a motion detector (PIR) can provide for a security breach via an input device, as could a door contact monitor.

The Intelligent Card Access controller 16 further comprises an authorization and network translation mechanism 30. The mechanism 30, receives the data acquired by the card access I/O devices 28, which is to be provided to the Internet host center 20, by the controller 16, via connection 26 and/or 27, with or without SSL. Depending on the authorization and network translation mechanism 30 and the selected secure transport protocol, the authorization mechanism 30, performs the tasks associated with network address translation, password generation and validation, and other tasks associated with a particular secure transport protocol.

The mechanism 30 controls the card access I/O devices 28 responsive to parameters obtained from respective Internet host centers 20. These parameters preferably are received by the Intelligent Card Access controller 16 from the Internet host center 20. To do so, parameters preferably are included in a download from the Internet host center 20, e.g., the controller“s configuration when the controller is initially establishing connection. However, some or all of the parameters can be received otherwise, without departing from the principles of the invention.

The authorization and network translation mechanism 30 preferably provides other functionality. For example, if the data received from the card access I/O devices 28 is in improper form, the mechanism 30 preferably is enabled to control conditioning the data to a proper form, said form generally yet being representative of the acquired data. Moreover, the mechanism 30, in conjunction with the card access I/O devices 28, preferably supports safeguards against data loss, e.g., communications errors or connection failures. The mechanism 28, either with or without SSL, preferably is enabled to process the communication data so as to enhance the robustness of the data capture and transfer. The processing includes, for example, extracting redundant features of the data and/or otherwise compressing the data. Although these and other functions are preferred, it is to be recognized that the mechanism 30 may include or omit one or more of the described functions or include additional functions, without departing from the principles of the invention.

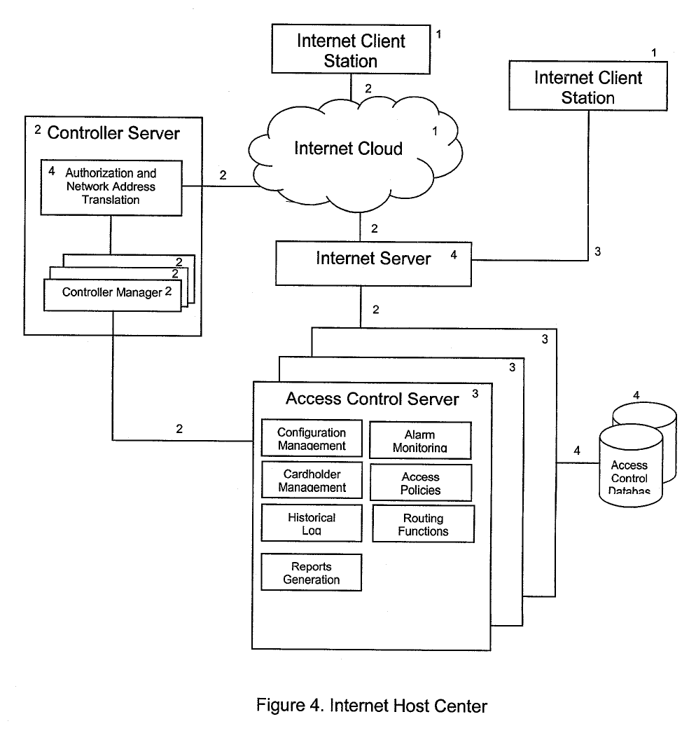

FIG. 4 shows an exemplary Internet host center 20 in greater detail. The Internet host center 20 comprises an Internet server 40 for making information, services and other resources, including Internet transactions, available to Internet client stations 14. The Internet server 40 preferably implements selected aspects of the authentication process hereof. For example, the Internet server 40 preferably provides parameters applicable to the Internet client station 14 seeking access and participates in establishing the secure transport protocol, e.g. SSL.

The Internet host center 20 preferably is associated with one or more access control servers 32. For example, access control servers 32 preferably are used to provide the information, services and other resources sought by an individual using the Internet client station 14. The access control servers 32, as used, generally have functions that depend on the specific card access and security operations supported. In the case of a card access system, the access control servers 32 can include, among others, Configuration functions, Cardholder Management, Access Policy Management, Historical Log, and Reports Generation. For Alarm Monitoring and Security, the access control servers 32 can include, among others, Alarm Management, Routing Functions, and also Report Generation.

The access control servers 32 link to the Internet client stations 14 via the Internet cloud or otherwise. The links can be through the Internet server 40 via connections 22 or outside the Internet server 40 via connections 34. In this regard, it is to be understood that, although the access control servers 32 are described and depicted in association with the Internet server 40, this description and depiction is a logical association, in that the Internet server 40 of the station 20 participates in authenticating individuals for access, such access typically being of the associated access control servers 32. As an example, any one or more of the access control servers 32 can be physically remote from the other, as well as being physically remote from the Internet server 40. In keeping with the logical association, the Internet server 40 and the access control servers 32 generally are, but need not be, operated by the same entity (e.g., the Internet server 40 can be operated by the entity that operates one or more of the access control servers).

FIG. 4 shows an exemplary Internet host center 20 with controller server 25. The controller server 25 comprises an authorization and network translation server 48, linked via element connections 28 to one or more access control servers 32, each of which servers are, in turn, linked via element connections 46 to one or more associated card access databases 44. The authorization and network translation server 48 controls communication between the controller manager 24 and the controller elements 16. The authorization and network translation servers 48 compare the controller addresses to address data originating from the pre-authorized controller records, such records being stored in the card access databases 44. The authorization and network translation server also provides the proper connection to the appropriate controller manager 24 instance and by connection means 28 to the proper intelligent access and security controller 32 instance. Such relationships are established at system configuration and runtime time.

The authorization and network translation server 48 also can comprise an Internet server 40, although it is to be understood that the Internet server 40 can be omitted for this purpose without departing from the principles of the invention. The Internet server 40 provides for communication via standard Internet protocols.

The element connections 26 preferably support a secure transport protocol, such as SSL, so as to provide secure channels among the center's elements. In certain configurations of the system 10, element connections 46 support standard Internet protocols, e.g., HTTP. Such configuration is contemplated, for instance, when the controller manager 24 is providing pages to the Internet host center 20 relating to the access control and security functions. Although these standard protocols are preferred, it is to be recognized that the mechanism 26 may include or omit one or more of the secure transport protocol layers or include other layers, without departing from the principles of the invention.

Although FIG. 4 shows elements of the Internet host center 20 logically together, it is to be recognized that the elements can be disposed at physically remote locations without departing from the principles of the invention. For example, any one or more of the card access databases 44 can actually comprise plural databases, each physically remote from the other and physically remote from the associated card access server 32, which itself can be physically remote from the authorization and network translation server 48 and controller manager 24.

Operation and Methods

The card access and security system 10 typically has two modes of operation: configuration and event notification. With configuration, administrators provide data to the Internet host center 32 identifying what components comprise the system, their addressing and component location, and what operational behavior to expect and provide notification upon. These include acceptable locations to provide access to certain individual holding access tokens, appropriate times to allow these accesses, and what to consider “normal” versus alarm and security breach conditions. Administrators through Internet clients 14 accomplish the process of system configuration and setup. Part of this is providing identity to operators of the system by user name, or by the Internet location of the individual's Internet client station 14 (Uniform Resource Locator (“URL”) or a network address), or by other identification parameter (E-Mail, pager, or WAP device address) or a combination.

Configuration includes the dissemination of the systems behavior information to the individual intelligent card access and security controllers requiring such data for proper operation. In a preferred embodiment, intelligent card access and security controllers are autonomous once downloaded with information. They receive this downloaded configuration information and can make local decisions about who is allowed to access particular doors and when. They determine what inputs are monitored for alarm conditions and when. They perform these functions and report the resultant activity to the Internet host center 20 through the Internet cloud 12. The activities are in the form of messages and are referred to as “events”. If connection between intelligent card access and security controllers 16 is temporarily disrupted or not available, then in a preferred embodiment, these events are placed in a message queue for delivery at a subsequent time. Numerous alternative methods are available for subsequent delivery attempts including (i) try N times to perform delivery, (ii) wait certain time intervals for repeated attempts, and (iii) use alternative and backup communication channels. It is to be recognized that a preferred method of alternative communication to the Internet Cloud 12 for this purpose, as contemplated by this invention, is Wireless methods 27, but that other methods such as Telephone Dial-up or dedicated telecommunications lines are also possible without departing from the principles of the invention.

In the first step of event notification, the authorization and network address translation server 48 receives encrypted messages carrying, for example, card access data and the individual's status. For example, “Admitted in” at the “Front Door” or “Denied” at “Lab Entrance” for particular individuals carrying access tokens. The authorization and network address translation server 48 preferably filters out unacceptable messages. Unacceptable messages can include those carrying a claimed source that does not agree with any origination records available at the controller manager 24. In this case, unacceptable messages, for example, can include those (i) associated with controllers who are not enrolled with the access control server 32, (ii) that do not have the appropriate password to validate their identity or (iii) associated or originate from a URL or a network location that are not registered with the Internet host center 20.

The authorization and network address translation server 48 preferably decrypts acceptable messages and passes them to access control server 32. (However, it is to be recognized that the messages can be passed to the access control server 32 without first being decrypted, in which case the access control server 32 performs the decryption.) The messages are passed to the access control servers 32 via element connectors 28, i.e., using a channel supporting SSL or some other protocol. The access control server 32 of each passed message can be determined by various factors, including (i) the server 32 has enrolled the claimed identity of the set of controllers seeking connection, and (ii) the Internet host center 20 has associated with it an instance copy of a server 32 for each controller 24 for which connection is sought. Accordingly, the authorization and network address translation server 48 preferably supports enrollment of sets of controllers 24 with respect to plural Internet host centers 20, each of which stations, for example, is in a captive structure with the controller manager 24, i.e., has control of a captive card access database 44 that includes records associated with that set. The authorization and network address translation server 48 preferably also supports enrollments associated with entirely independent structures, as well as with combinations of both configurations.

In configurations using passwords for authorization, the access control server 32 preferably determines whether the transmitted password matches the password of record. The access control server 32 can obtain the passwords of record in various ways. In a captive structure, the controller manager 24 has access to the applicable databases of the entity operating the Internet host center 20, including the databases 44 that maintain passwords. Accordingly, as non-card access passwords are added, dropped, or changed in the captive case, the controller manager 24 has automatic access to the new passwords. In an independent structure, the controller manager 24 generally is without access to the passwords of the Internet host center's database. Accordingly, the center 24 generally either/both maintains a password file (e.g., from enrollment) or obtains the password, in encrypted form, from the Internet host center 20 to match against that submitted for authentication.

Following each event, the access control server 32 produces a response. The server 32 provides the response, whatever its nature; to either/both the access control database 44 and the Internet client station 14, the routing of the response depending on the configuration of the system 10. In the case of a normal event, the access control server 32 preferably provides an update to the access control database 44. In that case, the access control server 32 preferably records the details of the event process so as to create a card access audit trail, as described below.

The access control server 32 can also route a response to one or more of the Internet client station 14 and the intelligent card access and security controllers 16 in the form of a notification event and in various ways. As an example, the access control server 32 can prepare and send to one or more client stations 14, a message that comprises a selected response to the event (e.g., notification for display purposes, or notification for alarm and for action response purposes), the message being suitable for downloading via the secure transport protocol or protocols in place between the center 20 and respective stations. The message includes many components including priority, related information, and if any actions like acknowledgement are expected of the operators. The notification message sets off a series of command and response sequences between the Internet client stations 14 and the access control server 32. Any and all these produce new events and messages, handled by the access control server 32, that preferably provides an update to the access control database 44 with event process details, to create further a card access audit trail. In such cases as prescribed responses are not met then an alternate message notification is produced by access control server 32 to an auxiliary list of Internet client stations 14 or alternative client station notification methods (e.g., E-Mail, WAP device, pagers, etc.). It is to be noted that both the primary and secondary notification methods are user based and independent of the user“s physical location. In both cases, any physical location that supports an Internet client station 14, connection, will provide event notification. Given the ubiquity of the Internet cloud 12, this is a significant advantage to this invention.

As another notification example, the access control server 32, can send a message via controller server 25, to any or all intelligent card access and security controllers 16, to provide an electronic link that provide immediate control of output and any annunciation devices. These can include horns and sirens for alarming purposes or control of physical devices for lock down purposes. Such messages are subject to individual authorization and network address translation at such individual intelligent card access and security controllers 16, through authorization and network translation mechanism 30, and/or with each authorization and network address translator 48. In such case, the authentication servers 30, 48 may or may not include an Internet server 40 so as to support the Internet protocols, e.g., HTTP.

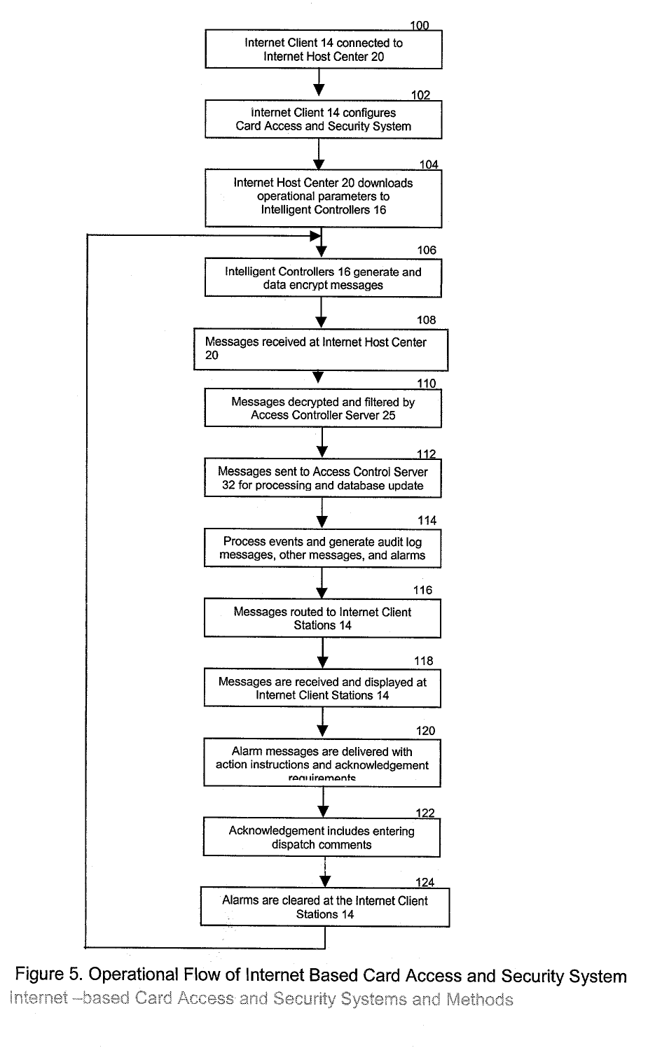

Turning to FIG. 5, a flow chart is shown that depicts the operation of the card access and security system 10, according to the present invention. In step 100, the Internet client station 14 requests access of an Internet host center 20. The station 14 typically does so by entering the Internet location of the Internet host center 20, such location being in the form of a Uniform Resource Locator (“URL”). In this step, a secure communication channel is established between the Internet client and host centers, via the Internet cloud 12. For example, if SSL is employed, the secure communication channel is established during the SSL handshake, including by, among other things, (i) negotiating an encryption algorithm between the stations 14, 20 via the Internet cloud 12 and (ii) authenticating the Internet client station 14 to the Internet host center 20.

In step 102, parameters are established at the Internet client station 14. The parameters are associated with the card access system operation to be used in authenticating the individuals seeking access of the particular Internet host center 20 and for system behavior and operation purposes. As previously described, the parameters preferably are provided from the Internet client station 14 to the Internet host center 20 by uploading pages from station 14 using HTTP over SSL. However, it is to be recognized that the parameters can be established otherwise, without departing from the principles of the invention.

In step 104, parameters are downloaded to intelligent card access and security controllers 16. The parameters are segregated by controller and are associated with the card access system operation, to be used for these specific devices, at this particular location. As previously described, the parameters preferably are provided from the Internet host center 20 to the intelligent card access and security controller 16 by downloading pages from center 20 using HTTP over SSL. However, it is to be recognized that the parameters can be established otherwise, without departing from the principles of the invention.

In step 106, the card access reader I/O devices 28 and security I/O devices 29 associated with the parameters generate card access and/or security events. The event activity is queued by the authorization and network translation mechanism 30.

In step 108, encryption is performed. Preferably, any authorization password and the card access and/or security data, or data representative thereof, are encrypted.

In step 110, a message is received at a controller server 25. The message preferably is received via one or more secure communication channels, e.g., a channel supporting SSL or some other security protocol. The controller server 25 filters out unacceptable messages. Unacceptable messages are described above. If a message is filtered out, the server 25 preferably sends a predetermined reject message to the Internet host center 20.

In step 110, the controller server 25 also decrypts acceptable messages. This decrypting action is to recover the card access data and, if used, to validate any password.

In step 112, the data (e.g., the acquired card access and/or security data or data representative thereof) is conveyed to an access control server 32 for processing and for updating access control database 44.

As previously discussed, the system 10 contemplates one or more controller servers 25 supporting one or more access control servers 32. In turn, the method for using the system 10 contemplates using said support to advantage. For example, as previously described with reference to FIG. 4, each access control server 32 can be used to process, in relation to one of the Internet host centers 20, one card access customer. As another example, however, a plurality of card access servers 32 can be used to authenticate in relation to a single Internet host center 20, a plurality of card access customers. In that latter example, the card access servers 32 can be organized to process in parallel, serially or in combinations of both. The parallel processing can be implemented for various purposes, including (i) for redundancy, (ii) to employ various process steps or resulting actions to one card access event type or (iii) to employ respective processing algorithms to various card access event types.

In step 114, based on the result of the processing, the access control server 32 produces a response for logging and audit trail purposes only or generates additional events for distribution. If the data is such that it indicates that this is an activity that should be further processed, the center 20 will have been configured to initiate additional card access processing, e.g., by sending a message from the Internet host center 20 to the Internet client station 14, the message providing additional or substitute data. As another example, if the event is card access activity such that access has been denied to a certain token holder, an alarm message can be generated and sent, requiring further actions by an operator. The system 10 can also be configured to initiate additional card access processing in the form of marking access individuals as in or out, within certain regions, or outside these regions, and other similar personnel tracking activities.

Moreover, additional processing is contemplated in response to alarmed conditions. In that regard, steps 116-122 provide that the access control server 32 records the details of the alarm handling process. These details include one or more of: the time and the date of each action, and some or all of the handling activity of the alarm message by the Internet client station 14 and the Internet server station 20. The activity includes, without exhaustion, delivering of priority information, action instructions with the alarm, any acknowledgement requirements, and the need for entering and recording of dispatch comments. These records create a card access audit trail so as to provide information for future analysis and reporting functions also available at the Internet client stations 16. In step 124, the alarm is cleared at the Internet client station by an operator indicating that the alarm handling has been completed and the cycle is repeated for additional alarms.

As previously described, handling parameters preferably are included in the configuration of the Internet host center 20 from the Internet clients station 14. Indeed, the downloaded information can include parameters that offer alternatives that are selectable. The selection can be made at the individual's volition (e.g., the card access characteristic or combinations that are acceptable to the individual), automatically by the Internet client station 14 (e.g., based on supported alarm handling characteristics), or by combinations of these or otherwise.

However, some or all of the parameters can be established otherwise, without departing from the principles of the invention. For example, after the first message, parameters can be communicated from the Internet host center 20 in one or more subsequently downloaded pages from the Internet host center 20. These parameters can be supplementary, substitutional or negotiable in nature.

Supplementary communication, from whatever source, can be used, for example, where the existing parameters can be incompatible with the Internet client station 14. That incompatibility, which can be an issue particularly in remote areas, can arise due to various factors, including, without exhaustion: (i) a communication link associated with a client 16 is absent or, if present, is not functional; (ii) the Internet browser client 17 fails to support a particular page download associated with a parameter; (iii) the individual device is unable to provide input response data associated with the event: and (iv) simply the client is not available and connected to an Internet client station 14. Supplementary transmission, from whatever source, can be used, in another example, where the existing link can be incompatible with the intelligent card access and security controller 16. That incompatibility, can arise due to various factors, including, without exhaustion: (i) the communication link to the controller server 25 is absent or, if present, does not function; and (ii) the connection does not properly support authentication based on a correct password or other data security requirement.

The systems and methods according to this invention, including the described embodiments, provide various advantages. Some of the advantages include, for example: card access data and functions are logically available at a central location-the Internet host center 20—for access by individuals within the context of any Internet-connected facilities; access requires no special or dedicated hardware or software at the accessing location, only Internet connectivity and a client supporting web browsing; access is generally available, rapid, reliable and secure; the system is relatively cost effective, especially compared to systems using dedicated hardware and software solutions; the system is highly scalable and yet, customizable to individual users and customers, both (i) in terms of providing various levels of functions available to and selectable by each entity and (ii) in terms of providing alternative card access characteristics for selection by each individual, responsive to the individual's (or, as the case may be, their Internet client station's) abilities, impairments and principles.

While the invention has been described in connection with preferred embodiments, it will be understood that modifications thereof within the principles outlined above will be evident to those skilled in the art and thus the invention is not limited to the preferred embodiments but is intended to encompass such modifications.

What is claimed is:

1. A system for providing card access and security system operation, the system using an Internet cloud as a communication medium and a host station for handling the processing for a multitude of remote sites, the system comprising: at least one Internet client station linked to the Internet cloud; at least one intelligent card access or security controller providing selected live event data operation to the Internet cloud; at least one Internet host center linked to the Internet cloud handling said messages from one or more systems and controllers; and a data center for housing, storing, and archiving said data and the configuration and logic for handling such real time data; the Internet host center linked to the cloud to provide connection to the Internet to handle requests from one or more Internet clients, to respond with data to Internet client stations in response to requests, and to deliver unsolicited, high priority events to said clients wherever they may be connected on the Internet.

2. The system as claimed in claim 1, wherein the Internet client stations and the Internet host centers are linked to the Internet cloud via Internet connections, the Internet connections supporting a secure transport protocol.

3. The system as claimed in claim 2, wherein the Internet host center is linked to at least one card access or security controller via Internet connections, the Internet connections supporting a secure transport protocol.

4. The system as claimed in claim 3, wherein at least one of the Internet connections and one of the card access and security controller connections support HTTP.

5. The system as claimed in claim 3, wherein the card access and security controller connections are via a wireless connection to the Internet.

6. The system as claimed in claim 1, wherein the Internet host center can support multiple Internet client stations and authenticate each client“s privilege to access data.

7. The system as claimed in claim 6, wherein one or more of the Internet client stations can simultaneously access the Internet host center to receive real time updates, database reports, and historical archives.

8. The system as claimed in claim 6, wherein one or more of the Internet clients can configure and setup the security logic and alarm handling behavior of the card access and security system.

9. The system as claimed in claim 7, wherein the Internet host center comprises one or more Internet access servers, the Internet access servers providing some or all of the configuration parameters associated with system behavior.

10. The system as claimed in claim 1, wherein the Internet host center comprises multiple subsystems to accommodate multiple sets of Internet clients and multiple sets of card access and security controllers.

11. The system as claimed in claim 10, wherein the Internet host center comprises multiple subsystems, linked, respectively, to one or more card access databases, the databases being captive.

12. The system as claimed in claim 1, wherein the Internet host center comprises multiple subsystems, linked, respectively, to one or more card access databases, at least one of the databases being independent.

13. The system as claimed in claim 1, wherein the Internet host center comprises an Internet server, the Internet server providing to the Internet client station some or all of the parameters associated with client authentication.

14. The system as claimed in claim 10, wherein the Internet host center comprises an authorization server linked to one or more card access servers, each of the card access servers being linked, respectively, to one or more card access databases.

15. The system as claimed in claim 10, wherein at least one of the card access servers is independent.

16. A method for Internet-based, card access and security event distribution to Internet client stations, the clients seeking access of an Internet host center, the method comprising the steps of: establishing parameters associated with selected characteristics to be used in the event distribution; acquiring, at the intelligent card access or security controller, card access data in accordance with the parameters; receiving, at the Internet host center, a message that includes response data; selecting, at the Internet host center, one or more records from among records associated with one or more client individuals; distributing event data with selected records, and logging the event data for reporting and archival purposes.

17. A method as claimed in claim 16, further comprising the steps of: providing, at the Internet client station, designated event data in HTML format; a time sequenced queue of data; and facilities to handle and otherwise respond to the data by said client.

18. A method as claimed in claim 16, further comprising the step of providing, from the Internet client station, a response acknowledging the delivery of the event data, this responding step comprising the steps of: (A) preparing the response, which step includes one or more of the following steps: (i) acknowledging the event; (ii) preparing a written response having template links to accessible handling data; (iii) preparing an appropriate entry in a log from a provided selection list; and (iv) preparing a secure protocol message; and (B) effecting the response, which step includes one or more of the following steps: (i) redirecting the response to an alternative Internet client station; (ii) routing the response to the alternative Internet client station via the Internet; (iii) processing the acknowledgement responses from the alternative client; (iv) and logging the responses to an archive.

19. A method as claimed in claim 16, further comprising the step of establishing secure communication channels in and among the Internet client station and the Internet host center.

20. A method as claimed in claim 19, wherein the step of establishing secure communication channels employing an Internet client at the Internet client station and a Internet server at the Internet host center, the Internet client and the Internet server providing for establishing a secure communication channel between the Internet client station and the Internet host center.

21. A method as claimed in claim 16, further comprising the step of recording selected details of the distributed message and the results of the acknowledging step so as to create a card access audit trail.

22. A method as claimed in claim 16, wherein: the acquiring step comprises plural acquisitions, said plural acquisitions relating to one or more card access characteristics; and the establishing parameters step further comprises at least one of the following steps: (i) combining said acquisitions from among supported sources, said combinations based on Boolean and other logical operations associated with single card access characteristics and with combinations of card access characteristics; and (ii) selecting a trigger event, said trigger event causing the acquisition or combination of card access data.

23. A method as claimed in claim 22, wherein the step of selecting a trigger event comprises selected time interval for repeating the acquisition or combination steps.

24. A method as claimed in claim 16, wherein the step of establishing parameters comprises one or more communications by and among the Internet host center and the intelligent card access and security controller.

25. A method as claimed in claim 24, wherein the step of establishing parameters further comprises downloading a page from the Internet host center to the Intelligent card access and security controller responsive to the Internet client station requesting same of the Internet host center, the page including parameters.

26. A method as claimed in claim 25, wherein the step of downloading a page from the Internet host center comprises the step of including parameters that offer alternatives, the alternatives being selectable.

27. A method as claimed in claim 16, further comprising the step of determining a server center from among plural server centers.
